(19) United States
(12) Patent Application Publication
(10) Pub. No.: US 2020/0011754 A1
(43) Pub. Date: Jan. 9, 2020

(54) PRESSURE DETECTION UNIT AND PRESSURE SENSOR USING SAME

(71) Applicant: FUJIKOKI CORPORATION, Tokyo (JP)

(72) Inventors: Tomohisa AOYAMA, Tokyo (JP); Motohisa MUKAI, Tokyo (JP); Youko TAMURA, Tokyo (JP); Tomonori SHIMURA, Tokyo (JP); Kai OGIWARA, Tokyo (JP); Osamu TAKATSUKI, Tokyo (JP)

(21) Appl. No.: 16/459,966

(22) Filed: Jul. 2, 2019

(30) Foreign Application Priority Data
Jul. 3, 2018 (JP) 2018-126756

(51) Int. Cl. G01L 19/00; G01L 19/06; G01L 19/14; B23K 35/32; B23K 1/00; G01L 9/00

(52) U.S. Cl. CPC G01L 19/0069; G01L 19/0645; G01L 19/142; G01L 9/0041; B23K 35/32; B23K 1/0016; G01L 19/0672; G01L 19/147

(57) ABSTRACT

The present invention provides a pressure detection unit and a pressure sensor using the same that have a high degree of airtightness and that are capable of suppressing bonding defects even when the base is made of ceramics. In the pressure detection unit, a linear expansion coefficient of ceramic that forms the ceramic base 110 is set to Δ1 (10⁻⁶/K) and a linear expansion coefficient of metal that forms the metal ring member 140 is set to Δ2 (10⁻⁶/K), a relationship of 0.7×Δ2≤Δ1 exists between the linear expansion coefficients Δ1 and Δ2, and the metal ring member 140 is formed of a metal such as SUS420J2, SUS410, or SUS444, for example, which does not precipitate aluminum oxide on a brazing surface with a projecting portion.

### CROSS-REFERENCE TO RELATED APPLICATIONS

The present application claims priority of Japanese patent application No. 2018-126756 filed on Jul. 3, 2018, the entire contents of which are hereby incorporated by reference.

### TECHNICAL FIELD

The present invention relates to a pressure detection unit and a pressure sensor using the same.

### BACKGROUND ART

Liquid-sealed pressure sensors, in which a semiconductor-type pressure sensor device is housed in a pressure receiving chamber partitioned by a diaphragm and filled with oil, are installed in refrigerators/freezers and air conditioners, and are used to detect refrigerant pressure. Such pressure sensors are also used in automobile fuel supply systems and are used for the detection of fuel pressure or the like.

Semiconductor-type pressure detection devices are disposed in the pressure receiving chamber, and have a function for converting a pressure change in the pressure receiving space into an electrical signal and outputting the signal to the outside through a relay substrate, a lead wire, or the like.

Depending on the environment where the pressure sensor is installed and the operational state of the device, a liquid such as water may enter into the sensor from the outside, which may cause problems in the semiconductor-type pressure detection device. Accordingly, pressure sensors are known that have improved water tightness by means of attaching a cover to the base in which the semiconductor-type pressure detection device is accommodated, and sealing this cover with an adhesive agent inserted therein (see Patent Document 1).

In the pressure sensor disclosed in Patent Document 1, the pressure detection unit is typically configured by overlapping the base, the diaphragm, and the receiving member and welding them to form a single body after the semiconductor-type pressure detection device is attached to a center portion on the inner surface side of the base.

At this time, since these members are each formed of a metal material such as stainless steel, the semiconductor-type pressure detection device attached to the base has a problem in that distortion due to expansion or contraction is detected as a pressure fluctuation of the detection target in the thermal history when circumferential welding is performed.

With respect to this, Patent Document 2 discloses a technique for eliminating distortion of the base by brazing a base made of ceramic and a stainless steel receiving member.

### CITATION LIST

### Patent Literature

[Patent Document 1] Japanese Unexamined Patent Application Publication No. 2012-68105 A
[Patent Document 2] Japanese Unexamined Patent Application Publication No. 2017-146137 A

### SUMMARY OF INVENTION

### Technical Problem

Here, according to the technique disclosed in Patent Document 2, the distortion caused by welding can be eliminated by using a ceramic base. However, according to the investigative results of the present inventors, it was discovered that, depending on the brazing conditions and the material characteristics of the members when brazing the ceramic base and the receiving member, aluminum oxide was deposited on the brazing surface.

Accordingly, an object of the present invention is to provide a pressure detection unit and a pressure sensor using the same that have a high degree of airtightness and sufficient bonding strength even when the base is made of ceramic.

### Solution to Problem

In order to achieve the above object, the pressure detection unit according to the present invention comprises a ceramic base; a metal ring member joined to the ceramic base by brazing; a receiving member joined to the metal ring member by welding; a diaphragm interposed between the metal ring member and receiving member; and a semiconductor pressure detection device attached to the ceramic base in a pressure receiving space formed between the ceramic base and the diaphragm; wherein a linear expansion coefficient of ceramic that forms the ceramic base is set to Δ1 (10⁻⁶/K) and a linear expansion coefficient of metal that forms the metal ring member is set to Δ2 (10⁻⁶/K), a relationship of 0.7×Δ2≤Δ1 exists between the linear expansion coefficients Δ1 and Δ2, and the metal ring member is formed of a metal that does not precipitate aluminum oxide on a brazing surface with the ceramic base.

According to the present invention, a pressure detection unit and a pressure sensor using the same that have a high degree of airtightness and sufficient bonding strength even when the base is made of ceramic can be provided.

### BRIEF DESCRIPTION OF FIGURES

FIG. 1 is a top view of a pressure detection unit according to a first embodiment of the present invention.

FIG. 2 is a side view of a cross section taken along the line A-A in FIG. 1.

FIG. 3 is a longitudinal sectional view of a pressure sensor using the pressure detection unit according to the first embodiment.

FIG. 4 is a cross-sectional view corresponding to FIG. 2 that illustrates a first modification of the first embodiment.

FIG. 5 is a cross-sectional view corresponding to FIG. 2 that illustrates a second modification of the first embodiment.

FIG. 6 is a longitudinal sectional view of a pressure sensor using the pressure detection unit according to the second embodiment.

### DESCRIPTION OF EMBODIMENT(S)

### First Embodiment

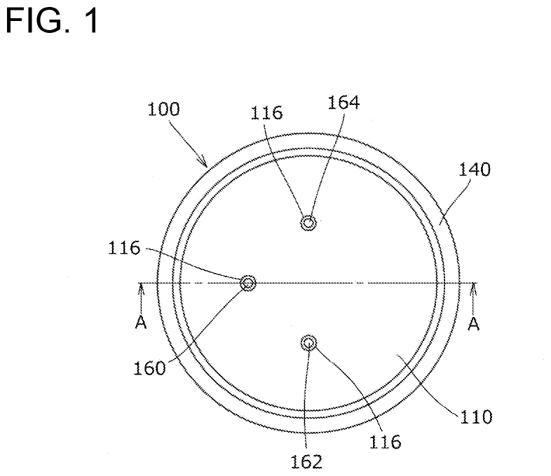

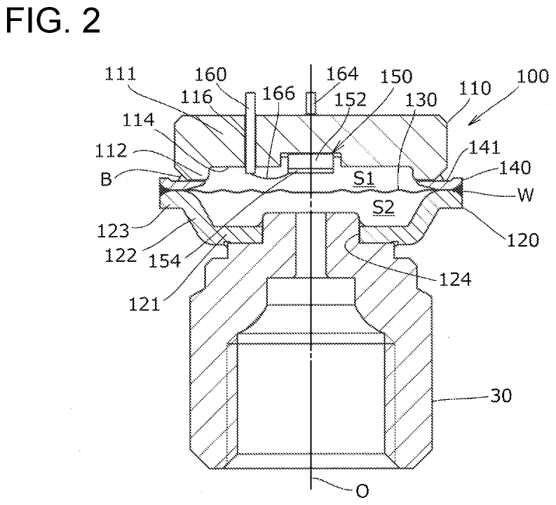

FIG. 1 is a top view of a pressure detection unit according to a first embodiment of the present invention, and FIG. 2 is a side view of a cross section taken along the line A-A of FIG. 1.

As illustrated in FIG. 1 and FIG. 2, the pressure detection unit 100 includes a base 110 made of ceramic, a receiving member 120 opposing the base 110, and a diaphragm 130 and a ring member 140 interposed between the base 110 and the receiving member 120.

The base 110 is provided with a disk-shaped main body 111 and a protruding portion 112 that protrudes axially and annularly around the entire outer periphery of the main body 111. That is, the base 110 has a shape in which a lower surface central portion in FIG. 2 is recessed so as to form the pressure receiving space S1 described later.

As the ceramic material that forms the base 110, alumina or alumina zirconia, or the like can be used, for example. Here, the linear expansion coefficient Δ1 of alumina is 7.7 (10⁻⁶/K), and the thermal conductivity thereof is 15 (w/m·K). The linear expansion coefficient Δ1 of alumina-zirconia is 8.4 (10⁻⁶/K), and the thermal conductivity thereof is 27 (w/m·K).

An airtight pressure receiving space S1 is formed between an inner portion 114 of the base 110 and the diaphragm 130, and is filled with an insulating liquid medium such as oil. In addition, the semiconductor-type pressure detection device 150 to be described later is attached to a central portion on the pressure receiving space S1 side of the main body 111 inside the protruding portion 112. It should be noted that, although a base which includes the protruding portion 112 was used in this embodiment, a disk-shaped base that does not include the protruding portion may also be used.

As illustrated in FIG. 1, three through holes 116 into which three terminal pins 160, 162 and 164 are inserted are formed at peripheral locations around the semiconductor type pressure detection device 150 in the base 110.

Each of the three terminal pins 160, 162, 164 penetrates the base 110 by being inserted through the through holes 116 provided in the base 110, and the lower ends thereof are electrically connected to the semiconductor-type pressure detection device 150.

The receiving member 120 is a plate-shaped member formed of a metal material such as, for example, a stainless steel plate, and is press-formed such that the central portion is recessed. The receiving member 120 includes a circular bottom portion 121, a conical portion 122 that extends upward from the outer edge of the circular bottom portion 121, and a flange portion 123 that extends horizontally from the outer edge of the conical portion 122.

An opening 124 for attaching the fluid inflow pipe to be described later is formed at the center of the circular bottom portion 121, and a diaphragm 130 is joined to the upper surface of the flange 123. By means of this structure, a pressurized space S2 into which the fluid that serves as the detection target flows is formed between the receiving member 120 and the diaphragm 130.

The diaphragm 130 is, for example, a disk-shaped thin plate member formed of a metal material such as stainless steel. Also, the ring member 140 is a ring-shaped member made of martensitic stainless steel or ferritic stainless steel, specifically, any of SUS420J2, SUS410, or SUS444 according to the JIS standard. Since stainless steel that does not contain aluminum is used for the ring member 140, aluminum oxide is not deposited on the brazing surface with the projecting portion of the base as a result of brazing, and the bonding strength is not reduced.

Here, the linear expansion coefficient Δ2 of SUS420J2 is 10.3 (10⁻⁶/K), and the thermal conductivity thereof is 24.7 (w/m·K). The linear expansion coefficient Δ2 of SUS410 is 9.9 (10⁻⁶/K), and the thermal conductivity thereof is 24 (w/m·K). Furthermore, the linear expansion coefficient Δ2 of SUS444 is 10.6 (10⁻⁶/K), and the thermal conductivity thereof is 26 (w/m·K).

The semiconductor pressure detector 150 is die-bonded to the central portion of the base 110 by adhesion or the like. The semiconductor-type pressure detection device 150 in this embodiment includes a support substrate 152 made of glass and a pressure detection element (semiconductor chip) 154 bonded thereto.

Although not illustrated in the Figures, the pressure detection element 154 is provided with, for example, eight bonding pads (electrodes) on its surface. Three of the bonding pads are a power supply input pad for an output signal, a ground pad, and a signal output pad, and the remaining five are signal conditioning pads.

(Assembly Process of Pressure Detection Unit 100)

The process of assembling the pressure detection unit 100 will be described below. First, the terminal pin 160 for grounding, the terminal pin 162 for power supply input, and the terminal pin 164 for signal output are respectively inserted into the through holes 116 formed in the base 110, and the three terminal pins 160, 162, 164 and the base 110 are bonded by brazing.

In particular, the ceramic of the base 110 and the metal of the terminal pins 160, 162, 164 are brazed by heating to a predetermined temperature in a state in which a brazing material such as silver solder is interposed between the through holes 116 formed in the base 110 and the terminal pins 160, 162, 164.

Bonding between the base 110 and the ring member 140 is performed by brazing the protruding portion 112 of the base 110 to the upper surface 141 of the ring member 140. In particular, a brazed portion B is formed around the entire circumference between the ceramic material of the base 110 and the metal material of the ring member 140 by heating to a predetermined temperature in a state in which a brazing material such as silver solder is interposed between the base 110 and the ring member 140, for example. The heating for brazing the base 110 and the ring member 140 is performed by the same process as brazing of the terminal pins 160, 162, 164.

In addition, before performing the brazing operation, by preliminarily forming a metallization layer (for example, a Mo—Mn layer or the like or a layer with tungsten as the main component) on the surface of the base 110 that is in contact with the brazing material, the bondability between the ceramic material and the brazing material can be enhanced.

Subsequently, the semiconductor-type pressure detection device 150 is die-bonded to the central portion of the base 110. Thereafter, the ground pad, the power input pad and the signal output pad of the semiconductor pressure detector 150 are electrically connected to one end of each of the three terminal pins 160, 162 and 164 through the bonding wires 166, respectively.

Further, the above-described eight pads of the pressure detection element 154 of the semiconductor type pressure detection device 150 exposed in the base 110 are brought into contact with each of the above-mentioned probes, and a temperature correction operation (trimming operation) of the pressure detection element 154 is performed.

Here, with a load (pressure) applied to the pressure detection element 154 at a reference temperature (for example, room temperature), the output value output from the signal output pad or adjustment pad is read, the correlation between a predetermined pressure and output are obtained, and a correction factor (correction function) is set.

Next, in a state in which the diaphragm 130 is interposed between the receiving member 120 and the ring member 140 and the pressure receiving space S1 formed between the base 110 and the diaphragm 130 is filled with a liquid medium, the overlapping portion of the receiving member 120 and the ring member 140 is relatively rotated while irradiating a laser beam from the outer peripheral direction, and circumferential welding is continuously performed to form a welded portion W and integrate the receiving member 120, the diaphragm 130, and the ring member 140. In this way, the receiving member 120, the diaphragm 130, and the ring member 140 are integrated to constitute a pressure receiving structure (pressure detection unit 100).

It should be noted that, in addition to laser welding, fusion welding such as arc welding, or resistance welding such as seam welding can also be applied as the method of circumferential welding. In consideration of reducing the distortion due to welding, however, it is preferable to apply laser welding, electron beam welding or the like which have low heat.

The welded portion W is offset in a direction perpendicular to the axis O (FIG. 2) of the pressure detection unit 100 with respect to the brazed portion B of the ring member 140 and the protruding portion 112 of the base 110, and is disposed such that the brazed portion B does not overlap with the welded portion W when viewed from the axial direction of the pressure detection unit 100. That is, by separating the welded portion W from the brazed portion B, the influence of heat at the time of welding can be prevented from impacting the brazed portion B.

Here, the combinations of the material of the base 110 and the material of the ring member 140 are changed, and the linear expansion coefficients are compared.

(1) Linear expansion coefficient Δ1 when the material of the base 110 is alumina: 7.7 (10⁻⁶/K)

[a] Linear expansion coefficient Δ2 when the material of the ring member 140 is SUS420J2: 10.3 (10⁻⁶/K)

At this time, Δ1/Δ2=0.75, and the relationship of 0.7×Δ2=7.21<Δ1 (=7.7) is satisfied.

[b] Linear expansion coefficient Δ2 when the material of the ring member is SUS410: 9.9 (10⁻⁶/K)

At this time, Δ1/Δ2=0.78, and the relationship of 0.7×Δ2=6.93<Δ1 (=7.7) is satisfied.

[c] Linear expansion coefficient Δ2 when the material of the ring member 140 is SUS444: 10.6 (10⁻⁶/K)

At this time, Δ1/Δ2=0.73, and the relationship of 0.7×Δ2=7.42<Δ1 (=7.7) is satisfied.

(2) Linear expansion coefficient Δ1 when the material of the base 110 is alumina zirconia: 8.4 (10⁻⁶/K)

[a] Linear expansion coefficient Δ2 when the material of the ring member 140 is SUS420J2: 10.3 (10⁻⁶/K)

At this time, Δ1/Δ2=0.81, and the relationship of 0.7×Δ2=7.21<Δ1 (=8.4) is satisfied.

[b] Linear expansion coefficient Δ2 when the material of the ring member 140 is SUS410: 9.9 (10⁻⁶/K)

At this time, Δ1/Δ2=0.85, and the relationship of 0.7×Δ2=6.93<Δ1 (=8.4) is satisfied.

[c] Linear expansion coefficient Δ2 when the material of the ring member 140 is SUS444: 10.6 (10⁻⁶/K)

At this time, Δ1/Δ2=0.79, and the relationship of 0.7×Δ2=7.42<Δ1 (=8.4) is satisfied.

As described above, according to the present embodiment, in any combination, when the linear expansion coefficient of the ceramic forming the base 110 is set to Δ1 (10⁻⁶/K), and the linear expansion coefficient of the SUS forming the ring member 140 is set to Δ2 (10⁻⁶/K), the relationship 0.7×Δ2≤Δ1 is satisfied. For this reason, at the time that heating such as laser welding is performed, distortion due to thermal expansion is unlikely to occur between the base 110 and the ring member 140 joined via the brazed portion B, and a high degree of airtightness can be maintained.

The difference between the thermal conductivity of the base 110 and the thermal conductivity of the ring member 140 is preferably within ±20%.

In addition, when the ring member 140 contains aluminum as an additive, aluminum oxide is precipitated at the time of brazing, which negatively impacts the brazing characteristics. In contrast, according to the present embodiment, since the ring member 140 is formed of a stainless steel which does not contain aluminum as an additive, specifically, any of SUS420J2, SUS410, or SUS444, aluminum oxide does not precipitate on the brazed surface at the time of brazing, and good bonding can be ensured. It should be noted that it is also possible to use stainless steels other than those listed above, provided it is a material that does not precipitate aluminum oxide at the time of brazing.

(Pressure Sensor)

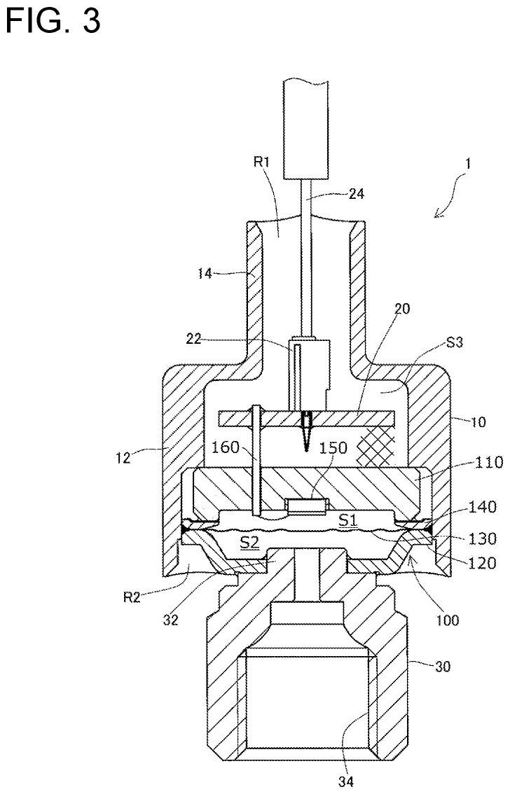

FIG. 3 is a longitudinal sectional view of a pressure sensor to which the pressure detection unit 100 according to the first embodiment is attached.

As illustrated in FIG. 3, the pressure sensor 1 includes the pressure detection unit 100 according to the present embodiment as illustrated in FIG. 1 and FIG. 2, the cylindrical cover 10 attached to the pressure detection unit 100, a relay substrate 20 to which one end of the three terminal pins (of which only 160 is illustrated in the Figure) projecting from the pressure detection unit 100 is attached, a connector 22 attached to the relay substrate 20, a lead wire 24 connected to the connector 22 for transmitting and receiving electrical signals and the like with external devices, and a fluid inflow tube 30 attached to the receiving member 120 of the pressure detection unit 100.

The cover 10 is a member having a stepped cylindrical shape including a large diameter portion 12 and a small diameter portion 14, and the pressure detection unit 100 is attached to the pressure detection unit 100 from the side of the base 110 in such a manner that the large diameter portion 12 surrounds the outer peripheral portion of the pressure detection unit 100.

As illustrated in FIG. 3, an inner space S3 that has the base 110 as its bottom surface is formed inside the cover 10, and the inner space S3 houses the relay substrate 20 and the connector 22 that will be described later.

The inner space S3 formed inside the cover 10 is filled with a resin R1 and this resin is solidified, and the open end side of the large diameter portion 12 is also filled with a resin R2 so as to cover the pressure detection unit 100, and this resin is also solidified.

These resins R1 and R2 prevent moisture and the like from entering the inside of the cover 10, and protect the electrical systems such as the relay substrate 20 and the like.

The relay substrate 20 is formed as a baked substrate, a glass epoxy substrate, a ceramic substrate, or a flexible substrate, and one end of the connector 22 is attached to the center thereof, and via electrodes and metal wiring layers are attached around the attachment location of the connector 22 (not illustrated in the Figures).

The connector 22 has one end attached to the relay substrate 20 and on the other end, a lead wire 24 that extends to the outside of the cover 10 is attached.

Further, one end of each of the three terminal pins (of which only 160 is illustrated in the Figures) protruding from the base 110 of the pressure detection unit 100 penetrates and is fixed to the via electrode of the relay substrate 20. At this time, the three terminal pins are fixed to and electrically connected with the via electrodes by soldering, for example.

The fluid inflow tube 30 is a tubular member made of a metal material such as a copper alloy or an aluminum alloy, and includes an attachment portion 32 that is attached to the receiving member 120 of the pressure detection unit 100, and a connection portion 34 connected to a pipe through which the fluid that serves as the pressure detection target flows.

The attachment portion 32 is attached to the opening 124 of the receiving member 120 illustrated in FIG. 2 by any method such as brazing, welding, adhesion or mechanical fastening.

(Assembly Process of Pressure Sensor)

When assembling the pressure sensor 1 illustrated in FIG. 3, first, the relay substrate 20 to which the connector 22 is attached is fixed to one end of the three terminal pins projecting from the base 110 of the pressure detection unit 100.

Then, the attachment portion 32 of the fluid inflow pipe 30 is attached and fixed to the opening 124 of the receiving member 120 of the pressure detection unit 100.

Next, the pressure detection unit 100 is inserted into the large diameter portion 12 of the cover 10 such that the lead wire 24 can be inserted from the large diameter portion 12 and exposed to the outside through the small diameter portion 14.

Subsequently, the resin R2 is filled from the open end on the side of the large diameter portion 12, and is solidified to fix the pressure detection unit 100 to the cover 10. Similarly, the resin R1 is filled from the opening on the side of the small diameter portion 14 of the cover 10 and is solidified to seal the inner space S3.

In the pressure sensor 1 illustrated in FIG. 3, the fluid that serves as the pressure detection target to be introduced into the fluid inflow pipe 30 enters the pressurized space S2 of the pressure detection unit 100, and this pressure deforms the diaphragm 130.

When the diaphragm 130 deforms, the liquid medium in the pressure receiving space S1 is pressurized, and the pressure resulting from the deformation of the diaphragm 130 is transmitted to the pressure detection element 154 of the semiconductor pressure detection device 150.

The pressure detection element 154 detects the fluctuation of the transmitted pressure and converts it into an electric signal, and outputs this electric signal to the relay substrate 20 through the terminal pin 164 for signal output.

Then, the electric signal is transmitted to the wiring layer of the relay substrate 20, and is further output to an external device through the connector 22 and the lead wire 24.

With such a configuration, since the pressure detection unit 100 according to the embodiments of the present invention and the pressure sensor 1 to which the pressure detection unit 100 is applied have a base 110 for attaching the semiconductor type pressure detection device 150 that is formed of a ceramic material having a small linear expansion coefficient, it is possible to suppress expansion or contraction of the base 110 due to, for example, the assembly manufacture of the pressure detection unit 100 or a change in the operating temperature environment of the pressure sensor 1.

In addition, since the base 110 is formed of a ceramic material having a small linear expansion coefficient, even in cases where the base 110 is exposed to harsh usage environments with high temperatures or low temperatures, the variation of the shape and size of the base 110 is reduced, and it is possible to suppress the reduction in detection accuracy due to the temperature environment of the semiconductor type pressure sensing device 150 in comparison to bases made of conventional metal materials.

Further, since the base 110 is formed of a ceramic material, it is possible to replace the glass hermetic seal used when embedding the terminal pins in the base in conventional pressure detection units with the brazed portion.

Furthermore, because the pressure detection unit 100 according to the present embodiment and the pressure sensor 1 to which the pressure detection unit 100 is applied form an integrated pressure receiving structure with the diaphragm 130 interposed between the receiving member 120 and the ring member 140, and the base 110 is joined to the ring member 140 of the pressure receiving structure, the diaphragm 130 can be reinforced by the receiving member 120 and the ring member 140.

(First Modification)

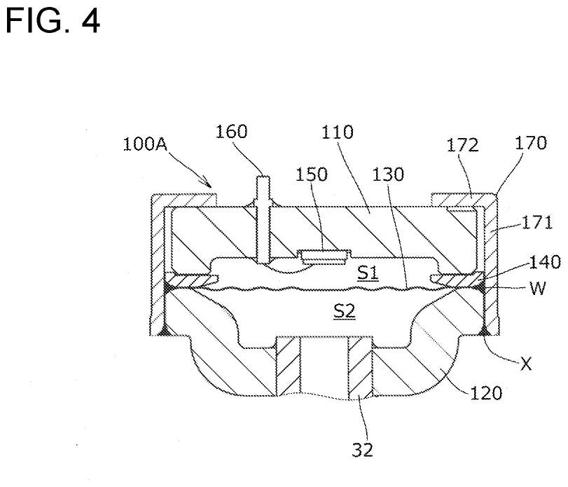

FIG. 4 is a cross-sectional view corresponding to FIG. 2 that illustrates a pressure detection unit 100A according to a first modification of the present embodiment. In the first modification, a holding member 170 that surrounds the receiving member 120, the ring member 140, and the base 110 is provided. This metal holding member 170 includes a hollow cylindrical portion 171 and an annular portion 172 extending inward from the upper end thereof. The rest of the configuration is the same as that of the above-described embodiment, so the same reference numerals are provided and redundant explanations are omitted.

Through a process similar to that of the above-described embodiment, the overlapping portion of the receiving member 120 and the ring member 140 is relatively rotated while irradiating a laser beam from the outer peripheral direction, and circumferential welding is continuously performed to form a welded portion W and integrate the receiving member 120, the diaphragm 130, and the ring member 140. After this integration, the holding member 170 is placed on the pressure receiving structure from above. With the annular portion 172 in contact with the upper surface of the base 110, the lower end of the hollow cylindrical portion 171 and the outer edge of the receiving member 120 are joined by laser welding to form a welded portion X.

Since a gap is formed between the hollow cylindrical portion 171 of the holding member 170 and the outer periphery of the base 110, in the case that the pressure detection unit 100A receives an impact, since it is difficult for shock and stress to be transmitted to the base 110 and the ring member 140, detection accuracy and durability of the pressure detection unit 100A and the pressure sensor can be improved.

(Second Modification)

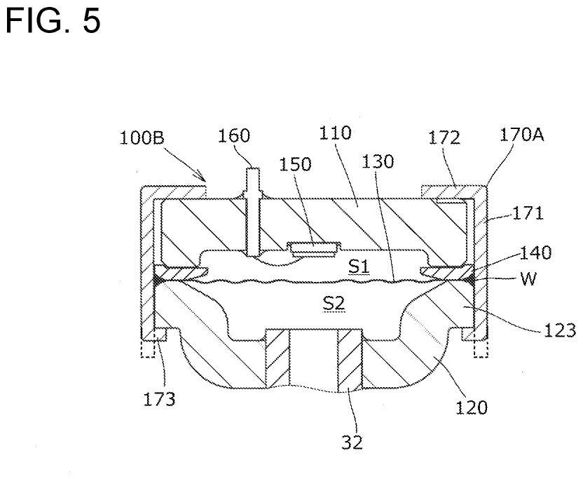

FIG. 5 is a cross-sectional view corresponding to FIG. 2 that illustrates a pressure detection unit 100B according to a second modification of the present embodiment. In the second modification as well, a holding member (fastening member) 170A that surrounds the receiving member 120, the ring member 140, and the base 110 is provided. Similar to the first modification, this metal holding member 170A includes a hollow cylindrical portion 171 and an annular portion 172 extending inward from the upper end thereof. However, as illustrated by the dotted line, the lower end of the hollow cylindrical portion 171 protrudes downward below the flange portion 123 of the receiving member 120. The rest of the configuration is the same as that of the above-described embodiment, so the same reference numerals are provided and redundant explanations are omitted.

Through a process similar to that of the above-described embodiment, the overlapping portion of the receiving member 120 and the ring member 140 is relatively rotated while irradiating a laser beam from the outer peripheral direction, and circumferential welding is continuously performed to form a welded portion W and integrate the receiving member 120, the diaphragm 130, and the ring member 140. After this integration, the holding member 170 is placed on the pressure receiving structure from above. With the annular portion 172 in contact with the upper surface of the base 110, the lower end of the hollow cylindrical portion 171 is fastened inwardly around the entire circumference to elastically deform it, thereby forming the fastened portion 173 and fixing it to the pressure receiving structure.

In this modification, the detection accuracy and durability of the pressure detection unit 100B and the pressure sensor can be improved as in the first modification, and since the holding member 170A and the receiving member 120 are not joined by laser welding, the influence of the heat to due to welding can be suppressed.

### Second Embodiment

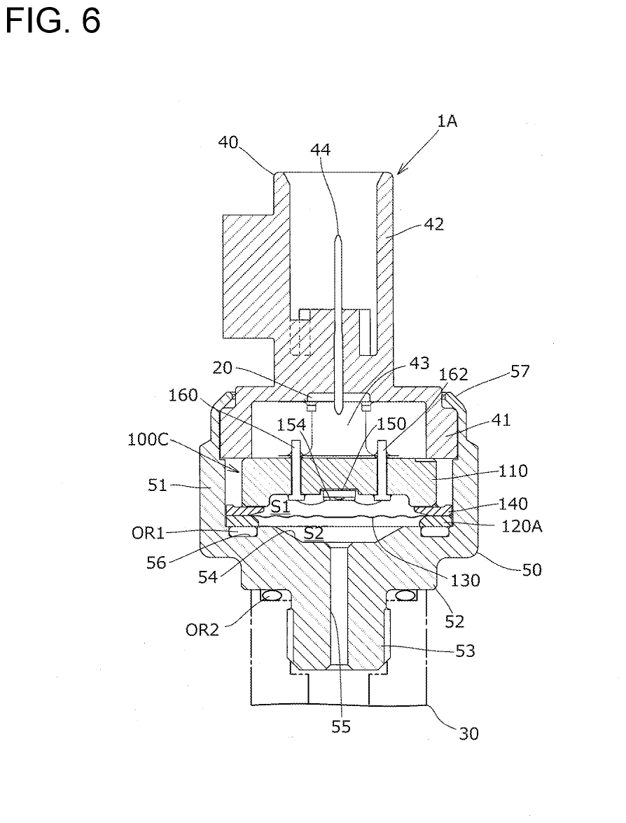

FIG. 6 is a cross-sectional view of a pressure sensor 1A using the pressure detection unit 100C according to the second embodiment. The same components as those of the first embodiment are denoted by the same reference numerals as those of the first embodiment, and redundant explanations will be omitted.

The receiving member 120A in the present embodiment is an annular plate. The base 110 and the ring member 140 are formed of the same material as in the embodiments described above.

The pressure detection unit 100C is connected to the male connector 40 via the fastening holding member 50. The fastening holding member 50 has a configuration in which the hollow large cylindrical portion 51, the stepped flange portion 52, and the small cylindrical portion 53 are connected in series.

In the large cylindrical portion 51, a recess 54 is formed at the center of the upper surface of the stepped flange portion 52, and a communication hole 55 is formed at the center. The communication hole 55 passes through the small cylindrical portion 53 and opens at the lower end thereof. A circumferential groove 56 is formed around the recess 54, and an O-ring OR1 is disposed therein.

The male connector 40 made of resin has a lower hollow cylindrical portion 41 and an upper hollow cylindrical portion 42, and the relay substrate 20 is attached to the center of the lower hollow cylindrical portion 41. The three terminal pins (of which only 160 and 162 are illustrated in the Figures) of the pressure detection unit 100C and the relay substrate 20 are electrically connected by the flexible printed circuit 43.

The relay substrate 20 is electrically connected to a connector pin 44 that extends from the lower hollow cylindrical portion 41 side to the inside of the upper hollow cylindrical portion 42. By fitting a female connector (not illustrated in the Figures) to the male connector 40, a signal detected by the pressure detection unit 100C can be output to the outside through the connector pin 44.

At the time of assembly, the pressure detection unit 100C is inserted into the large cylindrical portion 51 of the fastening holding member 50, and the lower end of the lower hollow cylindrical portion 41 of the male connector 40 is brought into contact with the upper surface of the base 110. Subsequently, the upper end of the large cylindrical portion 51 is fastened inwardly to cause elastic deformation, thereby forming the fastened portion 173 and fixing it in the vicinity of the upper end of the lower hollow cylindrical portion 41 of the male connector 40. As a result, the pressure detection unit 100C is gripped and held by the fastening holding member 50 and the male connector 40. However, a gap in the radial direction exists between the large cylindrical portion 51 and the base 110.

At this time, the fastening holding member 50 and the receiving member 120A come into contact with each other around the entire circumference via the O-ring OR1, and prevent the fluid that serves as the pressure detection target from leaking.

The fluid inflow tube 30 indicated by the dot-and-dash line is a tubular member made of a metal material such as a copper alloy or an aluminum alloy, for example, and is screwed and bonded to the outer periphery of the small cylindrical portion 53 of the fastening holding member 50. The upper end of the fluid inflow tube 30 and the fastening holding member 50 are connected by the ring OR2 in an airtight fashion.

In the pressure sensor 1A illustrated in FIG. 6, the fluid that serves as the pressure detection pressure target to be introduced into the fluid inflow pipe 30 enters the pressurized space S2 of the pressure detection unit 100C, and this pressure deforms the diaphragm 130.

When the diaphragm 130 deforms, the liquid medium in the pressure receiving space S1 is pressurized, and the pressure resulting from the deformation of the diaphragm 130 is transmitted to the pressure detection element 154 of the semiconductor pressure detection device 150.

The pressure detection element 154 detects the fluctuation of the transmitted pressure and converts it into an electric signal, and outputs this electric signal to the relay substrate 20 through the terminal pin for signal output (not illustrated in the Figures) and the flexible printed board 43.

Then, the electric signal is transmitted to the wiring layer of the relay substrate 20, and is further output to an external device through the connector 22 and the lead wire 24.

The present invention is not limited to the above embodiments, and various modifications can be performed.

### REFERENCE SIGNS LIST

1,1A Pressure sensor
10 Cover
20 Relay substrate
22 Connector
24 Lead wire
30 Fluid inflow tube
40 Male connector
50 Fastening holding member
100, 100A, 100B, 100C Pressure detection unit
110 Base
120, 120A Receiving member
130 Diaphragm
140 Ring member
150 Semiconductor-type pressure detection device
152 Support substrate
154 Pressure detection element
160 Terminal pin for grounding
162 Terminal pin for power supply input
164 Terminal pin for signal output
166 Bonding wire
170, 170A Holding member

What is claimed is:

1. A pressure detection unit comprising:
a ceramic base;
a metal ring member bonded to the ceramic base by brazing;
a receiving member bonded to the metal ring member by welding;
a diaphragm interposed between the metal ring member and the receiving member; and
a semiconductor pressure detection device attached to the ceramic base in a pressure receiving space formed between the ceramic base and the diaphragm;
wherein:
a linear expansion coefficient of ceramic that forms the ceramic base is set to Δ1 (10⁻⁶/K) and a linear expansion coefficient of metal that forms the metal ring member is set to Δ2 (10⁻⁶/K), a relationship of 0.7×Δ2≤Δ1 exists between the linear expansion coefficients Δ1 and Δ2, and the metal ring member is formed of a metal that does not precipitate aluminum oxide on a brazing surface with the ceramic base.

2. The pressure detection unit according to claim 1, wherein the metal that forms the metal ring member is martensitic stainless steel or ferritic stainless steel.

3. The pressure detection unit according to claim 1, wherein the metal that forms the ring member is any of SUS420J2, SUS410 or SUS444.

4. The pressure detection unit according to claim 1, wherein the ceramic that forms the ceramic base is alumina or alumina-zirconia.

5. The pressure detection unit according to claim 1, wherein a metallization layer is formed on the brazing surface of the ceramic base.

6. The pressure detection unit according to claim 1, wherein an outer periphery of the metal ring member and an outer periphery of the receiving member are bonded by welding to form a welded portion, and a brazed portion between the metal ring member and the ceramic base do not overlap with the welded portion when viewed from an axial direction of the pressure detection unit.

7. The pressure detection unit according to claim 1, further comprising a fastening member for fastening and holding the ceramic base and the receiving member from an outer peripheral side.

8. A pressure detection unit comprising:
a ceramic base of alumina or alumina-zirconia;
a metal ring member formed of any one of SUS420J2, SUS410, or SUS444 and bonded to the ceramic base by brazing;
a receiving member bonded to the metal ring member by welding;
a diaphragm interposed between the metal ring member and the receiving member; and
a semiconductor pressure detection device attached to the ceramic base in a pressure receiving space formed between the ceramic base and the diaphragm;
wherein:
the ceramic base includes a disk-shaped main body and a protruding portion that protrudes annularly around an entire outer periphery of the main body, and a recess for mounting the semiconductor pressure detection device is formed at a center portion of the main body surrounded by an annular portion;
the protruding portion of the ceramic base and the metal ring member are brazed, a linear expansion coefficient of ceramic that forms the ceramic base is set to Δ1 (10⁻⁶/K) and a linear expansion coefficient of metal that forms the metal ring member is set to Δ2 (10⁻⁶/K), a relationship of 0.7×Δ2≤Δ1 exists between the linear expansion coefficients Δ1 and Δ2, and the metal ring member is formed of a metal that does not precipitate aluminum oxide on a brazing surface with the ceramic base; and
an outer periphery of the metal ring member and an outer periphery of the receiving member are bonded by welding to form a welded portion, and a brazed portion between the metal ring member and the ceramic base do not overlap with the welded portion when viewed from an axial direction of the pressure detection unit.

9. The pressure detection unit according to claim 8, further comprising a fastening member for fastening and holding the ceramic base and the receiving member from an outer peripheral side.

10. A pressure sensor comprising:
the pressure detection unit of claim 1.

11. A pressure sensor comprising:
the pressure detection unit of claim 5.

12. A pressure sensor comprising:
the pressure detection unit of claim 6.

13. A pressure sensor comprising:
the pressure detection unit of claim 7.

14. A pressure sensor comprising:
the pressure detection unit of claim 8.

15. A pressure sensor comprising:
the pressure detection unit of claim 9.

16. The pressure sensor comprising:
the pressure detection unit of claim 1; and
a holding member configured to hold the pressure detection unit;
wherein:
a gap is formed between an outer periphery of a base of the pressure detection unit and the holding member.
